(19) United States
(12) Patent Application Publication
(10) Pub. No.: US 2026/0039055 A1
(43) Pub. Date: Feb. 5, 2026

(54) CONNECTOR

(71) Applicant: Bellwether Electronic Corp., Taoyuan City (TW)

(72) Inventors: Ching-Hsiang CHANG, Taoyuan City (TW); Hsing-Yu LEE, Taoyuan City (TW); Yung-Liang CHI, Taoyuan City (TW)

(21) Appl. No.: 19/090,406

(22) Filed: Mar. 26, 2025

Related U.S. Application Data
(60) Provisional application No. 63/677,414, filed on Jul. 31, 2024.
(60) Provisional application No. 63/700,779, filed on Sep. 30, 2024.

(30) Foreign Application Priority Data
Feb. 10, 2025 (TW) 114104890

(51) Int. Cl. H01R 13/627; H01R 13/629; H01R 25/14

(52) U.S. Cl. CPC H01R 13/6271; H01R 13/629; H01R 25/142

(57) ABSTRACT

A connector includes an insulating housing, at least one terminal set, and a latch member. The insulating housing includes a latch panel, a first part, a second part, a latching portion, and a guiding portion. The latch panel has a first surface and a second surface opposite to each other, and a latch opening is communicated with the first surface and the second surface. The first part is connected to the first surface and has at least one slot. The second part is connected to the second surface. The guiding portion is connected to the second surface. The terminal set is disposed in the slot. The latch member includes an actuating portion and a latch arm. The latch arm is connected to the actuating portion and is slidably engaged with the guiding portion and partially passes through the first surface via the latch opening.

### CROSS-REFERENCE TO RELATED APPLICATION

This application claims priority to U.S. Provisional Application Ser. No. 63/677,414 filed Jul. 31, 2024, Provisional Application Ser. No. 63/700,779 filed Sep. 30, 2024, and Taiwan Application Serial Number 114104890, filed Feb. 10, 2025, the disclosures of which are incorporated herein by reference in their entireties.

### BACKGROUND

### Field of Invention

The present disclosure relates to a connector.

### Description of Related Art

In recent times, as the performance requirements of servers in data processing and computing systems increase, the stability and convenience of connectors during use have become crucial. Some connectors conduct electricity by clamping copper sheets. An operator uses a screwdriver to tighten screws to lock the connector to a panel, and when the connector needs to be removed, the operator loosens the screws with a screwdriver to remove the connector from the panel.

However, although the conventional connector can be installed and removed, the locking position of the connector is often close to a wire, and the operator is limited by the space constraints imposed by the wire, resulting in difficulties in positioning the screwdriver and the screws at a suitable position to thereby make operation difficult.

Accordingly, providing a connector to solve the aforementioned problems has become an important issue to be solved by those in the industry.

### SUMMARY

An aspect of the disclosure is to provide a connector that can efficiently solve the aforementioned problems.

According to an embodiment of the disclosure, a connector includes an insulating housing, at least one terminal set, and a latch member. The insulating housing includes a latch panel, a first part, a second part, a latching portion, and a guiding portion. The latch panel has a first surface and a second surface opposite to each other, and a latch opening is communicated with the first surface and the second surface. The first part is connected to the first surface and has at least one slot. The second part is connected to the second surface. The guiding portion is connected to the second surface. The terminal set is disposed in the slot. The latch member includes an actuating portion and a latch arm. The actuating portion is configured to fasten the latching portion. The latch arm is connected to the actuating portion and is slidably engaged with the guiding portion and partially passes through the first surface via the latch opening when the actuating portion fastens the latching portion.

In an embodiment of the disclosure, the guiding portion includes a sliding groove communicated with the latch opening. The latch arm includes a protrusion. The latch arm is slidably disposed in the sliding groove.

In an embodiment of the disclosure, the latching portion is located at the second part. The latching portion and the guiding portion are respectively located on a first side and a second side adjacent to the second part.

In an embodiment of the disclosure, the second part has a first extension plate located on the first side. The latching portion is disposed on an outer surface of the first extension plate.

In an embodiment of the disclosure, the latching portion includes a rib disposed on the outer surface. The actuating portion includes a hook and a pressing portion. The hook is connected to the pressing portion. The hook is configured to fasten the rib.

In an embodiment of the disclosure, the outer surface has a recess. The pressing portion is configured to be pressed to enter the recess, so that the actuating portion is separated from the latching portion.

In an embodiment of the disclosure, the second part has a second extension plate located on a third side. The third side is opposite to the first side. The insulating housing includes a rear cover detachably covering a rear side of the first extension plate and the second extension plate away from the latch panel.

In an embodiment of the disclosure, the actuating portion further includes a pivot located between the hook and the pressing portion. The pivot is configured to abut against the outer surface of the first extension plate to act as a rotation pivot.

In an embodiment of the disclosure, the insulating housing further comprises two blocking blocks. The two blocking blocks are respectively connected to opposite sides of the first part and each forms a gap with the latch panel.

According to an embodiment of the disclosure, a connector includes an insulating housing, at least one terminal set, and a latch member. The insulating housing includes a latch mechanism, a first part, and a second part. The latch mechanism has a gap configured to receive a part of a panel. The first part is located on a first side of the latch mechanism and has at least one slot. The slot has openings on three sides of the first part. The second part is located on a second side of the latch mechanism opposite to the first side. The terminal set is disposed in the slot. The latch member is slidably disposed on the insulating housing and switches between a first state and a second state. When the latch member is in the first state, the insulating housing is able to be installed on the panel and undergoes a lateral movement. When the latch member is in the second state, the latch member limits the lateral movement of the insulating housing relative to the panel.

In an embodiment of the disclosure, the latch mechanism includes a latch panel and at least one blocking block. The blocking block is separated from the latch panel to form the gap.

In an embodiment of the disclosure, the latch panel has a first surface and a second surface opposite to each other, and a latch opening is communicated with the first surface and the second surface.

In an embodiment of the disclosure, the latch member includes a latch portion and an actuating portion. The latch portion slidably and partially passes through the first surface via the latch opening. The actuating portion is connected to the latch portion and is configured to slide on an outer surface of the second part.

In an embodiment of the disclosure, the insulating housing further includes a guiding portion connected to the second surface and aligned with the latch opening. The latch portion is slidably disposed in a sliding groove of the guiding portion.

In an embodiment of the disclosure, the latch portion is located on one side of the second part. The actuating portion is located on another side of the second part.

Accordingly, in the connector of the present disclosure, the latching portion is disposed on the first side of the second part, and the actuating portion of the latch member can be disposed on the side close to the operator to avoid being hindered by the wire, so that the latch member can be fastened and released more easily. When the pressing portion of the actuating portion is pressed, the rib of the latching portion and the recess on the first extension plate can make the pressing portion enter the recess, so that the second hook of the actuating portion is lifted up and leaves the rib by elastic deformation. By pressing the pressing portion and pushing (or pulling) the latch member toward the latch panel (or away from the latch panel) at the same time, the protrusion of the latch arm can be partially protruded from the first surface of the latch panel (or retracted into the latch opening without protruding from the first surface).

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view of a connector according to an embodiment of the present disclosure;

FIG. 2 is another perspective view of the connector in FIG. 1;

FIG. 3 is an exploded view of the connector in FIG. 1;

FIG. 4 is another exploded view of the connector in FIG. 1;

FIG. 5A is a partial cross-sectional view of the connector in FIG. 1 along the section line 5A-5A, wherein a latching portion and a second latch arm are in an unfastened state;

FIG. 5B is another partial cross-sectional view of the connector in FIG. 1 along the section line 5A-5A, wherein the latching portion and the second latch arm are in a fastened state;

FIG. 6 is a perspective view of two terminal sets of the connector in FIG. 1;

FIG. 7 is a perspective view of the connector in FIG. 1 with a rear cover and an electric sheet removed;

FIG. 8 is a perspective view of the connector in FIG. 1 with the rear cover removed;

FIG. 9 is a perspective schematic view of the connector in FIG. 1 and a corresponding panel;

FIG. 10 is a front view of the panel in FIG. 9;

FIG. 11A is a front view of the connector in FIG. 1 and the corresponding panel before being fastened together;

FIG. 11B is a back view of the connector in FIG. 1 and the corresponding panel before being fastened together;

FIG. 12A is a front view of the connector in FIG. 1 and the corresponding panel after being fastened together;

FIG. 12B is a back view of the connector in FIG. 1 and the corresponding panel after being fastened together;

FIG. 13 is a perspective view of a connector clamping a copper sheet according to another embodiment of the present disclosure;

FIG. 14 is a perspective view of a connector with wires connected on both sides according to another embodiment of the present disclosure;

FIG. 15 is a perspective view of a connector according to another embodiment of the present disclosure;

FIG. 16 is a perspective view of a connector according to another embodiment of the present disclosure; and

FIG. 17 is a perspective view of a connector according to another embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

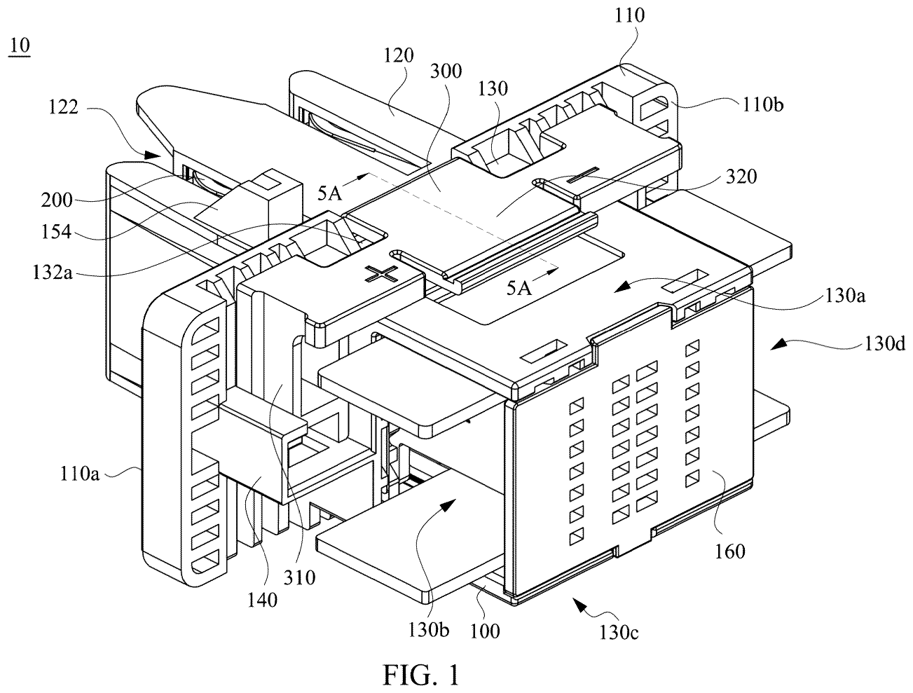

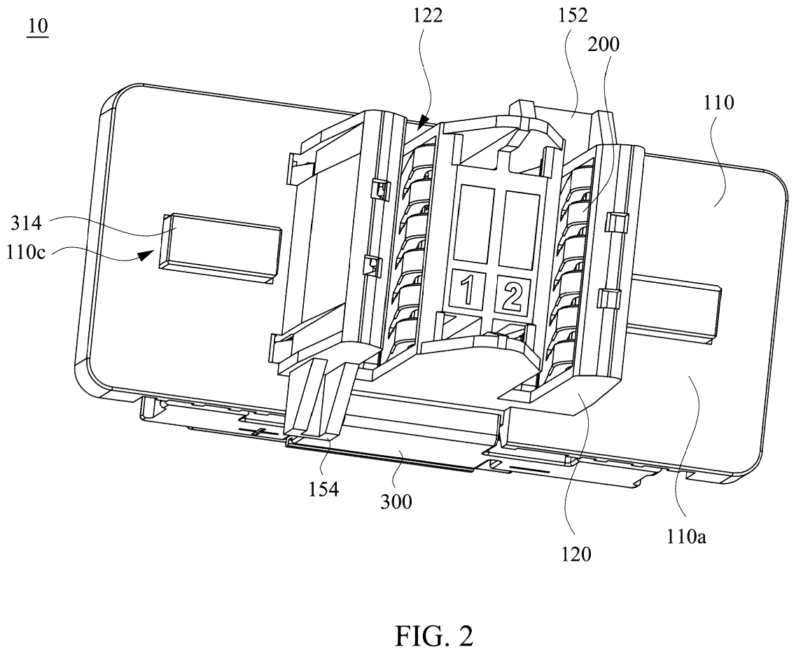

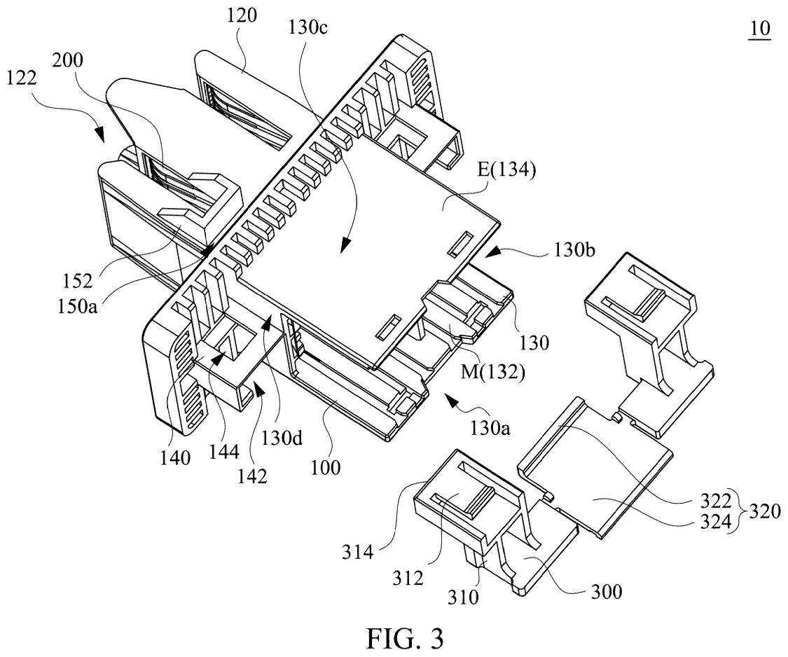

Reference is made to FIG. 1, FIG. 2 and FIG. 3. FIG. 1 is a perspective view of a connector 10 according to an embodiment of the present disclosure. FIG. 2 is another perspective view of the connector 10 in FIG. 1. FIG. 3 is an exploded view of the connector 10 in FIG. 1. As shown in FIGS. 1 to 3, in the present embodiment, a connector 10 includes an insulating housing 100, two terminal sets 200, and a latch member 300. The two terminal sets 200 are installed in the insulating housing 100. The latch member 300 is detachably and slidably disposed on the insulating housing 100 and is switchable between a first state (or a first position) and a second state (or a second position). When the latch member 300 is in the first state, the insulating housing 100 can be installed in an opening of a panel (not shown) and move laterally; when the latch member 300 is in the second state, the latch member 300 restricts the insulating housing 100 mounted on the panel from moving laterally.

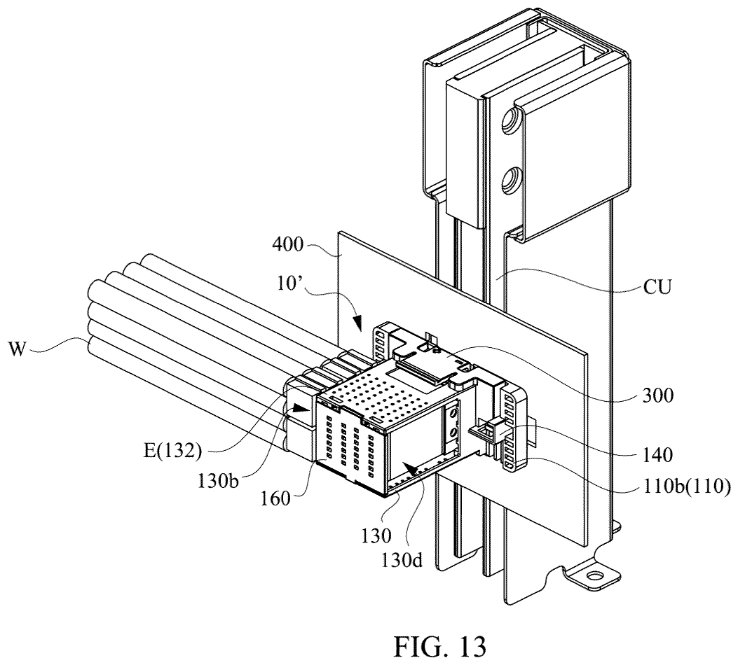

The insulating housing 100 includes a latch panel 110, a first part 120, and a second part 130. The latch panel 110 has a first surface 110a and a second surface 110b opposite to each other, and two latch openings 110c are communicated with the first surface 110a and the second surface 110b. The first part 120 is connected to the first surface 110a of the latch panel 110 and has two slots 122, and the two terminal sets 200 are respectively disposed in the two slots 122. The second part 130 is connected to the second surface 110b of the latch panel 110. The slot 122 has openings on three sides (i.e., the front side, and the upper and lower sides opposite to each other) of the first part 120, so when a copper sheet CU (see FIG. 13) is clamped in the slot 122, the copper sheet CU can extend out from the upper and lower sides.

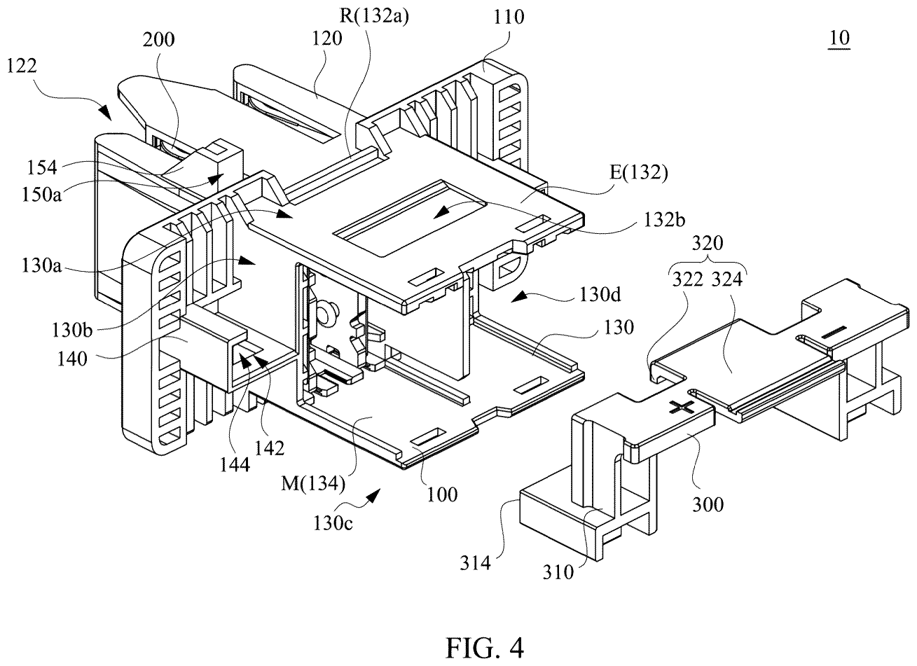

As shown in FIG. 1 and FIG. 3, the latch member 300 includes two first latch arms 310 and a second latch arm 320. The second latch arm 320 is connected between the two first latch arms 310, and the latch member 300 is U-shaped when viewed from the rear. The two first latch arms 310 are respectively slidably connected to two latch openings 110c along a first direction. The insulating housing 100 may further have two guiding portions 140, and the two guiding portions 140 are aligned with the two latch openings 110c. The two first latch arms 310 are respectively slidably connected to two guiding portions 140. In some embodiments, the first direction is a plugging direction of the connector 10, which is parallel to the direction of the slot 122. In the first direction, the frontmost end of the first latch arm 310 is located ahead of the frontmost end of the second latch arm 320. Reference is made to FIG. 4, which is another exploded view of the connector 10 in FIG. 1. The second latch arm 320 is configured to be latched (fastened) on a latching portion 132a on the insulating housing 100, so that the two first latch arms 310 are positioned relative to the insulating housing 100. The second part 130 has a second side 130b and a fourth side 130d opposite to each other, and a first side 130a and a third side 130c connect the second side 130b and the fourth side 130d and is opposite to each other. The second side 130b and the fourth side 130d each has an opening serving as an outlet for a wire (not shown). The two first latch arms 310 are respectively located at the second side 130b and the fourth side 130d, and are respectively connected to opposite sides of the second latch arm 320 located at the first side 130a. In this embodiment, since the latching portion 132a is located on the first side 130a of the second part 130, and the two guiding portions 140 are respectively located on the second side 130b and the fourth side 130d of the second part 130, an operator can press the second latch arm 320 on the first side 130a to fasten or release the latch member 300 on the insulating housing 100 without interfering with output wires (not shown) connected to the second side 130b and the fourth side 130d of the connector 10.

As shown in FIGS. 2 to 4, in this embodiment, the guiding portion 140 includes a sliding groove 142 and a box opening 144. The first latch arm 310 includes a first hook 312 and a protrusion 314. The first latch arm 310 is slidably inserted into the sliding groove 142. The sliding groove 142 is connected to the latch opening 110c. The first hook 312 is located at the outer side of a free end of an elastic arm structure and is formed by a protruding block, and a fixed end of the elastic arm structure is connected to the first latch arm 310. When installing the latch member 300 on the insulating housing 100, the latch member 300 is first held and pushed toward the latch panel 110 to place the first latch arm 310 into the sliding groove 142, and then is continuously slid until the first hook 312 enters into the box opening 144 to achieve the effect of locking the latch member 300 to the insulating housing 100. After the installation is completed, the first hook 312 is partially located within the box opening 144 to be movably limited within the range of the box opening 144. The protrusion 314 may partially penetrate the first surface 110a through the latch opening 110c (see FIG. 2). In this embodiment, when the first hook 312 abuts against the inner edge of the box opening 144 away from the latch panel 110, the protrusion 314 does not pass through the first surface 110a; when the first latch arm 310 slides along the sliding groove 142 and the first hook 312 leaves the aforementioned inner edge of the box opening 144, the protrusion 314 will pass through the first surface 110a.

The operation of the latch member 300 will be described with reference to FIGS. 1 and 2. In this embodiment, the first latch arm 310 may be used as a latch portion, and the second latch arm 320 may be used as an actuating portion. The two protrusions 314 are the front ends of the two first latch arms 310 facing the latch panel 110 (see FIG. 4). During the process of pushing the second latch arm 320, the two protrusions 314 will move along the inside of the guiding portion 140, and the front ends thereof will move toward the first surface 110a through the two latch openings 110c. When the second latch arm 320 is fastened to the latching portion 132a, the two protrusions 314 partially protrude from the first surface 110a and are respectively located at opposite sides of the two slots 122, but the disclosure is not limited in this regard. In some embodiments, only one of the two protrusions 314 may partially pass through the latch opening 110c to partially protrude from the latch panel 110 and to protrude from the first surface 110a, or only one of the two first latch arms 310 may have a protrusion 314 and partially pass through the latch opening 110c to partially protrude from the latch panel 110 and to protrude from the first surface 110a. In some embodiments, the insulating housing 100 may include only one latch opening 110c and one guiding portion 140, which are disposed on the second side 130b or the fourth side 130d of the insulating housing 100, and the latch member 300 may include only one first latch arm 310 slidably connected to the guiding portion 140 of the second side 130b or the fourth side 130d.

As shown in FIG. 3 and FIG. 4, in this embodiment, the second part 130 of the connector 10 has a first extension plate 132 located at the first side 130a and a second extension plate 134 located at the third side 130c. The first extension plate 132 and the second extension plate 134 each has an inner surface M and an outer surface E. The latching portion 132a is disposed on the outer surface E of the first extension plate 132. The latching portion 132a includes a rib R disposed on the outer surface E. The rib R may be a long rib, but the disclosure is not limited in this regard. The second latch arm 320 includes a second hook 322 and a pressing portion 324. The second hook 322 is connected to the pressing portion 324 and is configured to be fastened on the rib R.

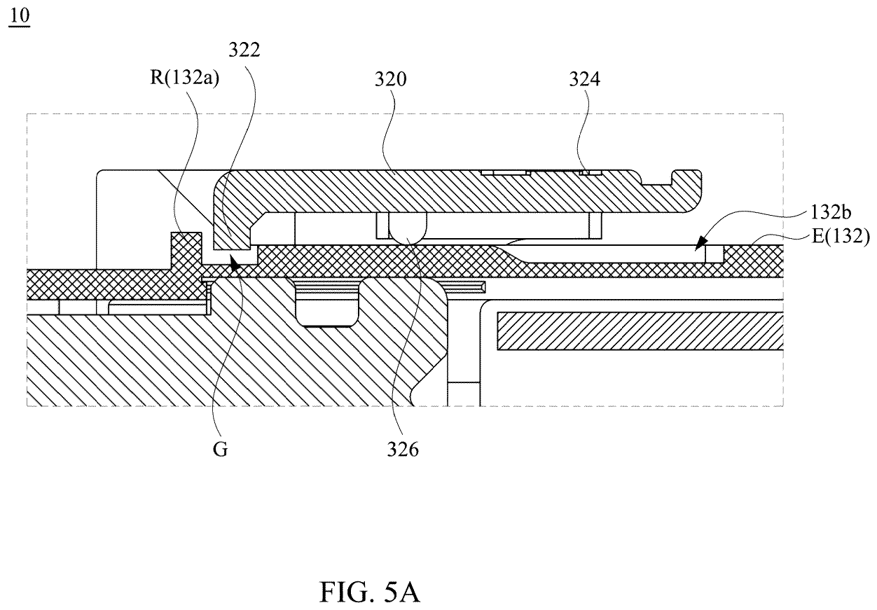

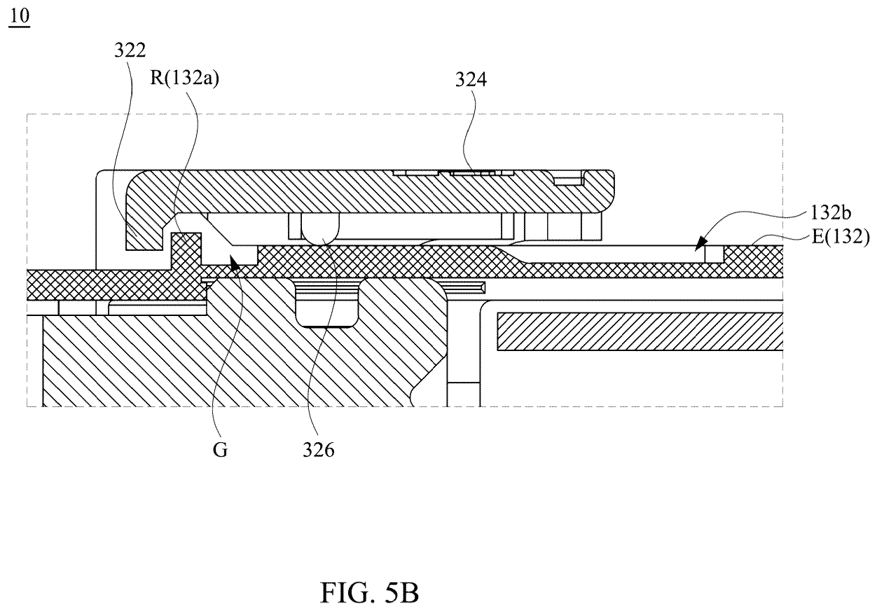

Reference is made to FIG. 5A and FIG. 5B. FIG. 5A is a partial cross-sectional view of the connector 10 in FIG. 1 along the section line 5A-5A, wherein the latching portion 132a and the second latch arm 320 are in an unfastened state. FIG. 5B is another partial cross-sectional view of the connector 10 in FIG. 1 along the section line 5A-5A, wherein the latching portion 132a and the second latch arm 320 are in a fastened state. As shown in FIG. 5A and FIG. 5B, in this embodiment, the outer surface E of the first extension plate 132 has a recess 132b. A portion or the entirety of the pressing portion 324 is disposed above the recess 132b and is configured to be pressed to enter the recess 132b. In some embodiments, when the second latch arm 320 is not fastened with the latching portion 132a (such as the first state shown in FIG. 5A), the second hook 322 is located in a groove G behind the latching portion 132a. When the latch member 300 is in the unfastened state shown in FIG. 5A (the connector 10 is in the first state), the protrusion 314 does not protrude from the first surface 110a of the latch panel 110. By applying an external force to the pressing portion 324 to make the pressing portion 324 enter the recess 132b, the second hook 322 of the second latch arm 320 can be separated from the groove G.

In short, when the pressing portion 324 is pressed, the second latch arm 320 will be elastically deformed and twisted relative to the first latch arm 310, thereby causing the second hook 322 to tilt up (similar to a seesaw). A pivot portion 326 may be protruded from a surface of the second latch arm 320 close to the outer surface E of the first extension plate 132. The pivot portion 326 is located between the second hook 322 and the pressing portion 324. When the pressing portion 324 is pressed, the pivot portion 326 abuts against the outer surface E of the first extension plate 132 and serves as a rotation pivot, so that the second hook 322 tilts up. Subsequently, the latch member 300 can be continuously pushed toward the latch panel 110 while pressing the pressing portion 324, so that the second latch arm 320 moves (slides) along the outer surface E of the first extension plate 132. After the second hook 322 crosses the rib R, the pressing portion 324 is released, so that the second hook 322 is fastened with the rib R (as shown in the second state in FIG. 5B). At this time, the latch member 300 is in the fastened state (the connector 10 is in the second state). When the second latch arm 320 is fastened with the latching portion 132a (as shown in FIG. 5B), the pressing portion 324 can be pressed to enter the recess 132b, so that the second hook 322 is separated from the rib R. Furthermore, by continuously pulling the latch member 300 away from the latch panel 110 while pressing the pressing portion 324, the second latch arm 320 moves (slides) along the outer surface E of the first extension plate 132, such that the second latch arm 320 and the latching portion 132a can be released from the fastened state. Subsequently, the pressing portion 324 is released to return the second hook 322 to the groove G (as shown in FIG. 5A), and the latch member 300 is returned to the unfastened state.

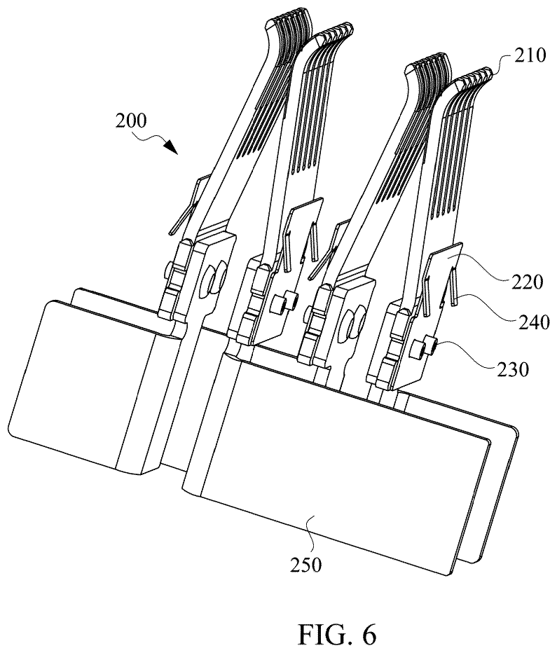

Reference is made to FIG. 6. FIG. 6 is a perspective view of two terminal sets 200 of the connector 10 in FIG. 1. Each of the two terminal sets 200 includes two contact portions 210, two lock sheets 220, a plurality of locking elements 230, and two electric sheets 250. The two terminal sets 200 include a power terminal set and a ground terminal. Each contact portion 210 includes a plurality of elastic arms, which are disposed on the first part 120 of the insulating housing 100 and are configured to clamp a copper sheet (not shown) and electrically connect a power copper sheet and a ground copper sheet of the copper sheet respectively. The distance between the two contact portions 210 gradually decreases at one end. The two lock sheets 220 are respectively locked on two outer sides of the two contact portions 210 by the locking elements 230. The two electric sheets 250 are disposed on the second part 130 of the insulating housing 100 and are respectively fixed to the two inner sides of the two contact portions 210 by the locking elements 230. Each of the two lock sheets 220 has at least one lock beam 240. The lock beam 240 is a portion of the lock sheet 220 that tilts toward the insulating housing 100 (i.e., toward the outside), and is configured to fix the two terminal sets 200 inside the insulating housing 100. In other words, the two terminal sets 200 are disposed in the first part 120 and the second part 130 in the insulating housing 100, and from the outside to the inside are the insulating housing 100, the lock sheet 220, the contact portion 210, and the electric sheet 250. The locking element 230 is configured to simultaneously lock the lock sheet 220, the contact portion 210 and the electric sheet 250. The electric sheet 250 is divided into a first part and a second part. The first part is locked with the contact portion 210. The second part and the first part are vertically connected to each other, and the second part is configured to electrically connect with wires or bus bars (not shown).

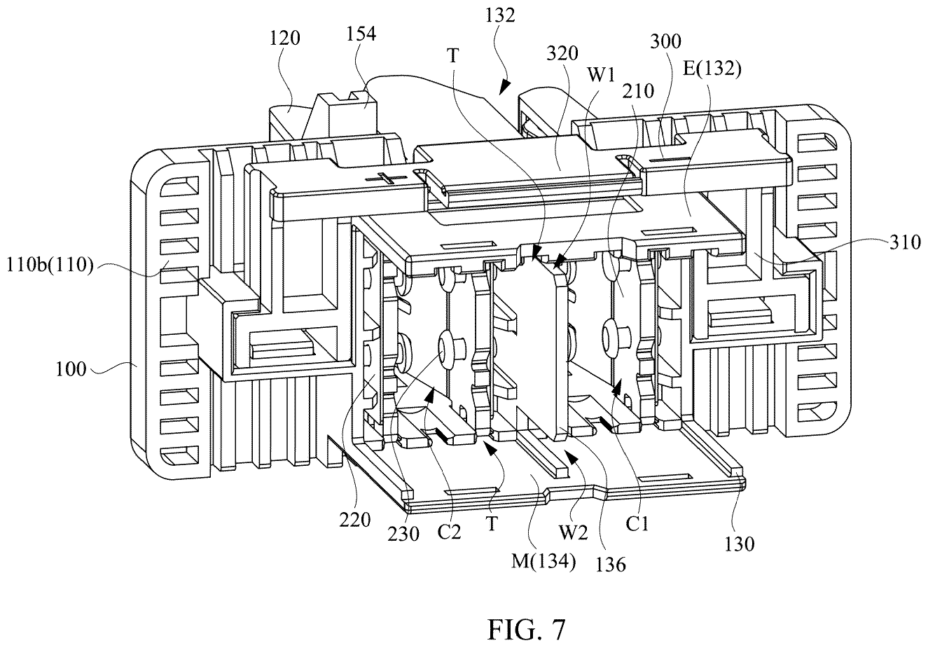

Reference is made to FIG. 7. FIG. 7 is a perspective view of the connector 10 in FIG. 1 with the rear cover 160 and the electric sheet 250 removed. As shown in FIG. 1, in this embodiment, the insulating housing 100 includes a rear cover 160 detachably covering the rear side of the first extension plate 132 and the second extension plate 134 away from the latch panel 110. As shown in FIG. 7, in this embodiment, the first extension plate 132 and the second extension plate 134 each has an inner surface M. The inner surface M includes a plurality of tracks T configured to receive a part of the two terminal sets 200. The two contact portions 210 of each terminal set 200 may be partially disposed in the track T to better fix/limit the terminal set 200 in the insulating housing 100. As shown in FIG. 7, in this embodiment, the second part 130 further includes a partition portion 136. The partition portion 136 is located between the first extension plate 132 and the second extension plate 134 and partitions into a first terminal channel C1 and a second terminal channel C2. In this embodiment, the two slots 122 are respectively connected to the first terminal channel C1 and the second terminal channel C2, and the two terminal sets 200 are respectively disposed in the first terminal channel C1 and the second terminal channel C2 and in the corresponding connected slots 122.

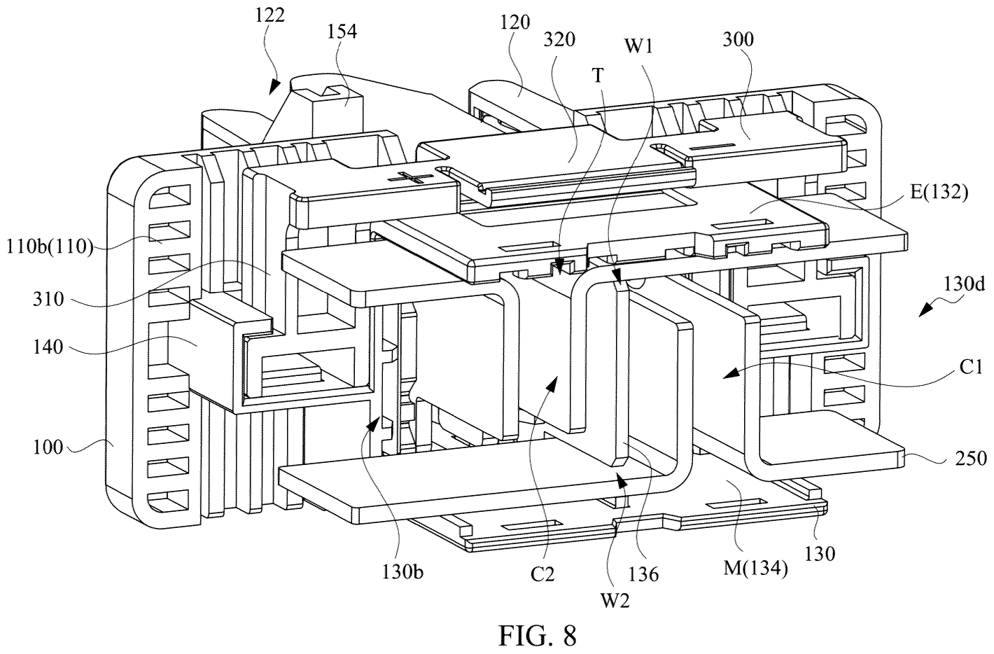

Reference is made to FIG. 8. FIG. 8 is a perspective view of the connector 10 in FIG. 1 with the rear cover 160 removed. As shown in FIG. 8, in this embodiment, the second part 130 further includes a first channel W1 and a second channel W2. The first channel W1 is formed between the first extension plate 132 and the partition portion 136, and connects the first terminal channel C1 and the second terminal channel C2. The second channel W2 is formed between the second extension plate 134 and the partition portion 136, and connects the first terminal channel C1 and the second terminal channel C2. In this embodiment, the first parts of the two electric sheets 250 of the two terminal sets 200 are located in the first terminal channel C1 and the second terminal channel C2. The second part of one of electric sheets 250 of the terminal set 200 of the second terminal channel C2 extends from the second terminal channel C2 through the first channel W1 and the first terminal channel C1 (not in physical contact with the terminal set 200 of the first terminal channel C1 and electrically isolated from each other) to the fourth side 130d of the second part 130. The second part of one of the electric sheets 250 of the terminal set 200 of the first terminal channel C1 extends from the first terminal channel C1 through the second channel W2 and the second terminal channel C2 (not in physical contact with the terminal set 200 of the second terminal channel C2 and electrically isolated from each other) to the second side 130b of the second part 130. In some embodiments, each of the two terminal sets 200 has an electric sheet 250 extending laterally to the second side 130b of the second part 130, and each of the two terminal sets 200 has another electric sheet 250 extending laterally to the fourth side 130d of the second part 130.

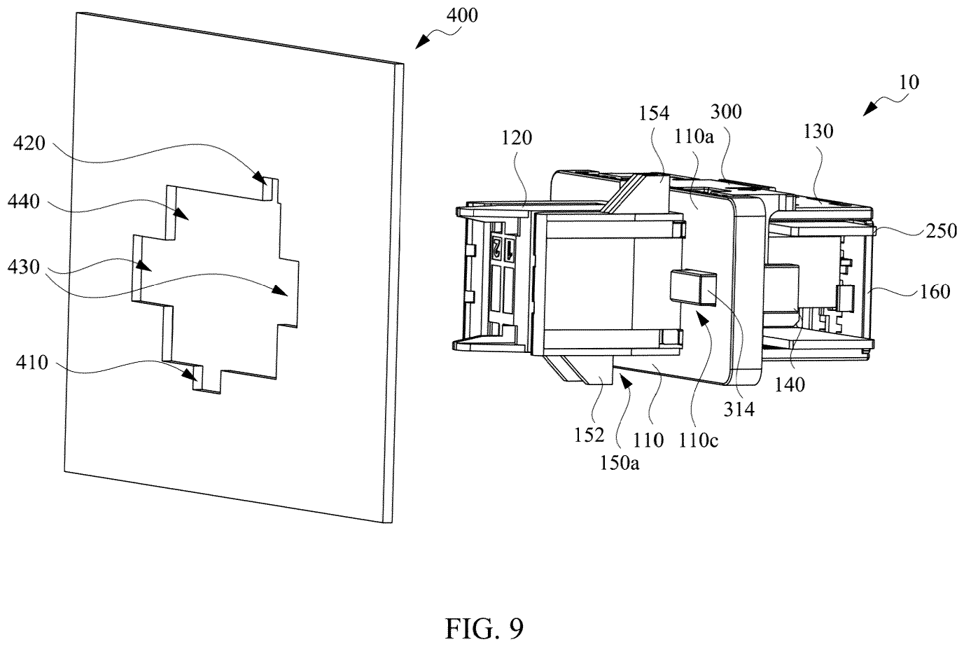

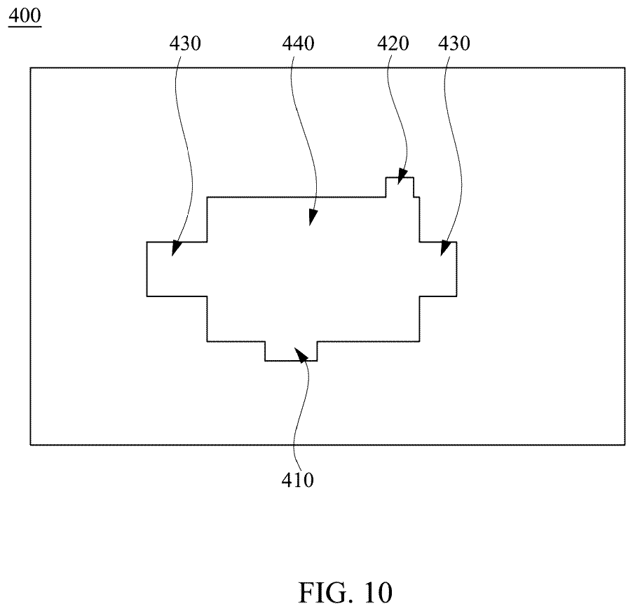

Reference is made to FIG. 9 and FIG. 10. FIG. 9 is a perspective schematic view of the connector 10 in FIG. 1 and the corresponding panel 400. FIG. 10 is a front view of the panel 400 in FIG. 9. As shown in FIG. 9, in this embodiment, the insulating housing 100 may further include a first blocking block 152 and/or a second blocking block 154. The first blocking block 152 and the second blocking block 154 are respectively connected to opposite sides of the first part 120, and the first blocking block 152 and the second blocking block 154 are each separated from the latch panel 110 to form a gap 150a there between. The gap 150a is equal to or greater than the thickness of the panel 400, so that the panel 400 can be partially accommodated in the gap 150a. In other words, the latch panel 110 and the first blocking block 152 and/or the second blocking block 154 together form a latch mechanism configured to pass through the opening 440 of the panel 400 and engage the panel 400 in the gap 150a. The first part 120 of the insulating housing 100 is located at a first side of the latch mechanism, and the second part 130 is located at a second side of the latch mechanism opposite to the first side. In this embodiment, the size of the first blocking block 152 is larger than the second blocking block 154 to have a fool-proofing effect, and the second blocking block 154 and the latching portion 132a of the second part 130 are located on the same side, but the disclosure is not limited in this regard. In some embodiments, the size of the first blocking block 152 and the second blocking block 154 may be equal, or the size of the second blocking block 154 may be larger than that of the first blocking block 152.

As shown in FIG. 9, in this embodiment, the connector 10 may be installed (mounted) on a panel 400, and the panel 400 may be a panel of a server. As shown in FIG. 10, in this embodiment, the panel 400 includes an opening 440. The inner edge of the opening 440 is partially expanded outward to form a first indentation 410, a second indentation 420, and two latch indentations 430. The first part 120 of the connector 10 passes through the panel 400 through the opening 440. The width of the first indentation 410 is greater than the width of the second indentation 420. The first blocking block 152 passes through the panel 400 through the first indentation 410. The second blocking block 154 passes through the panel 400 through the second indentation 420.

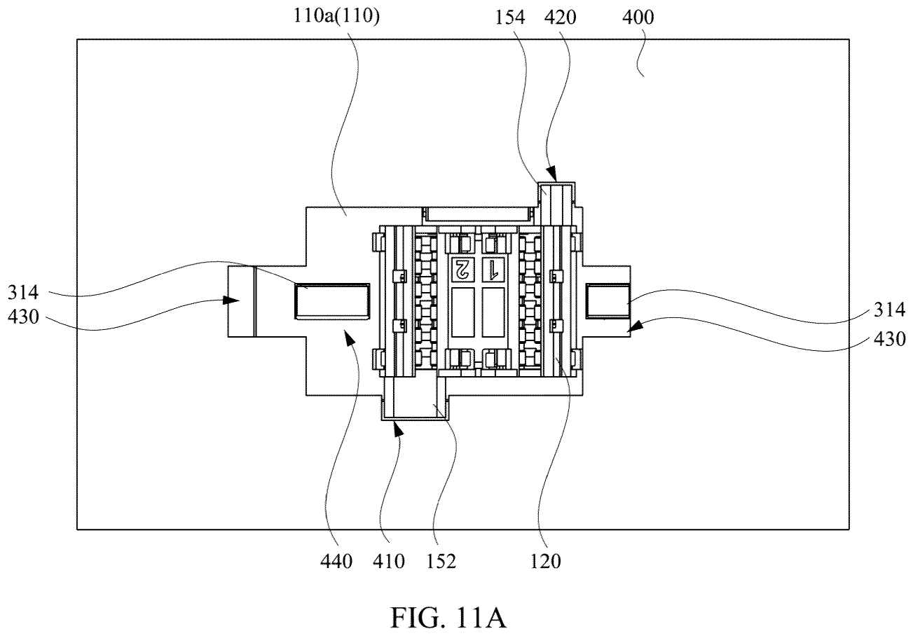

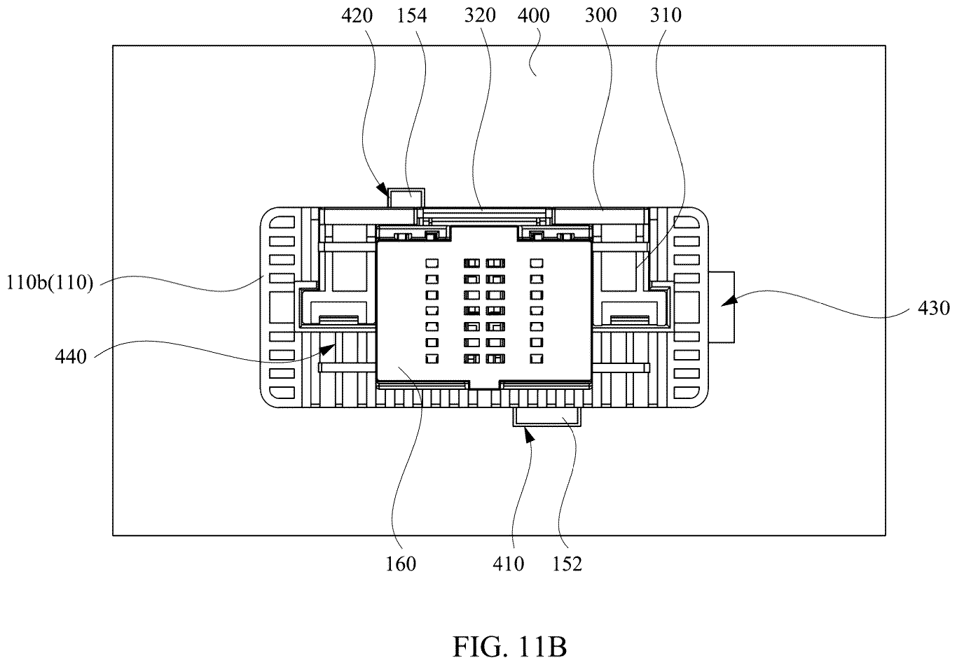

Specifically, only when the connector 10 and the panel 400 are in a specific relative position (such as the relative position in FIG. 11A) and state (for example, the connector 10 is in the first state) will the first indentation 410 and the second indentation 420 simultaneously and respectively align with the first blocking block 152 and the second blocking block 154 and allow the first blocking block 152 and the second blocking block 154 to pass through at the same time. After the first blocking block 152 and the second blocking block 154 pass through the first indentation 410 and the second indentation 420 simultaneously and respectively (the latch panel 110 is larger than the opening 440 or the shape of the latch panel 110 is inconsistent with the shape of the opening 440, and thus cannot pass through the opening 440), laterally changing the relative position of the connector 10 and the panel 400 will cause the first indentation 410 and the second indentation 420 to no longer align with the first blocking block 152 and the second blocking block 154 respectively, and cause the panel 400 to partially engage in the gap 150a.

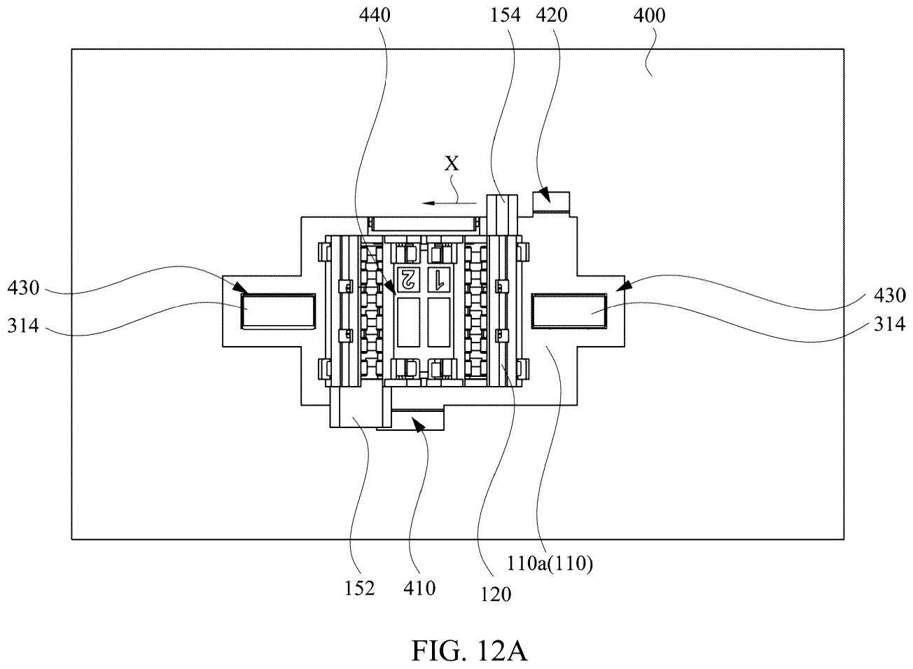

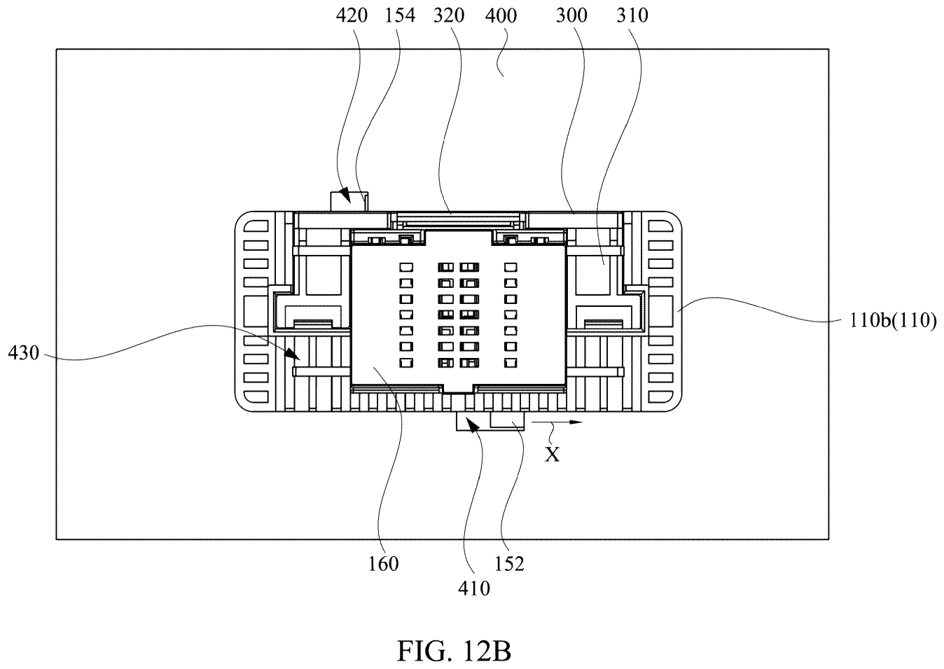

Reference is made to FIG. 11A to FIG. 12B. FIG. 11A is a front view of the connector 10 in FIG. 1 and the corresponding panel 400 before being fastened together. FIG. 11B is a back view of the connector 10 in FIG. 1 and the corresponding panel 400 before being fastened together. FIG. 12A is a front view of the connector 10 in FIG. 1 and the corresponding panel 400 after being fastened together. FIG. 12B is a back view of the connector 10 in FIG. 1 and the corresponding panel 400 after being fastened together. As shown in FIG. 11A and FIG. 11B, in this embodiment, during the process of installing the connector 10 on the server panel 400, in the unfastened state, the first part 120, the first blocking block 152, and the second blocking block 154 are aligned with the opening 440, the first indentation 410, and the second indentation 420, and then passed through the server panel 400 from the first side until the first blocking block 152 and the second blocking block 154 completely pass through the first indentation 410 and the second indentation 420. At this time, the first surface 110a of the latch panel 110 is close to or in contact with the surface of the first side of the server panel 400, and the protrusion 314 has not yet protruded from the first surface 110a of the latch panel 110. As shown in FIGS. 12A and 12B, in this embodiment, by moving the connector 10 laterally in the direction of arrow X that is perpendicular to the first direction, the first blocking block 152 and the second blocking block 154 gradually move away from the first indentation 410 and the second indentation 420. At this time, a part of the server panel 400 is engaged between the first blocking block 152 and the latch panel 110, and another part of the server panel 400 is engaged between the second blocking block 154 and the latch panel 110. Furthermore, the two latch openings 110c of the latch panel 110 are aligned with the latch indentations 430. Next, the second latch arm 320 is pushed to make the protrusion 314 protrude from the first surface 110a and enter the latch indentation 430, and the connector 10 is in the second state. Since the protrusion 314 is located in the latch indentation 430, the lateral movement range of the connector 10 in the opening 440 of the server panel 400 is limited, so that the first blocking block 152 and the second blocking block 154 can no longer be aligned and pass through the first indentation 410 and the second indentation 420, resulting in the connector 10 being fixed to the panel 400 to achieve a locking effect. The size of the latch indentation 430 may be slightly larger than that of the protrusion 314, so that the protrusion 314 can move within the range of the latch indentation 430 to the left or right or up or down within a limited distance on a plane perpendicular to the docking direction (first direction). This makes the connector 10 in the second state have a floating effect.

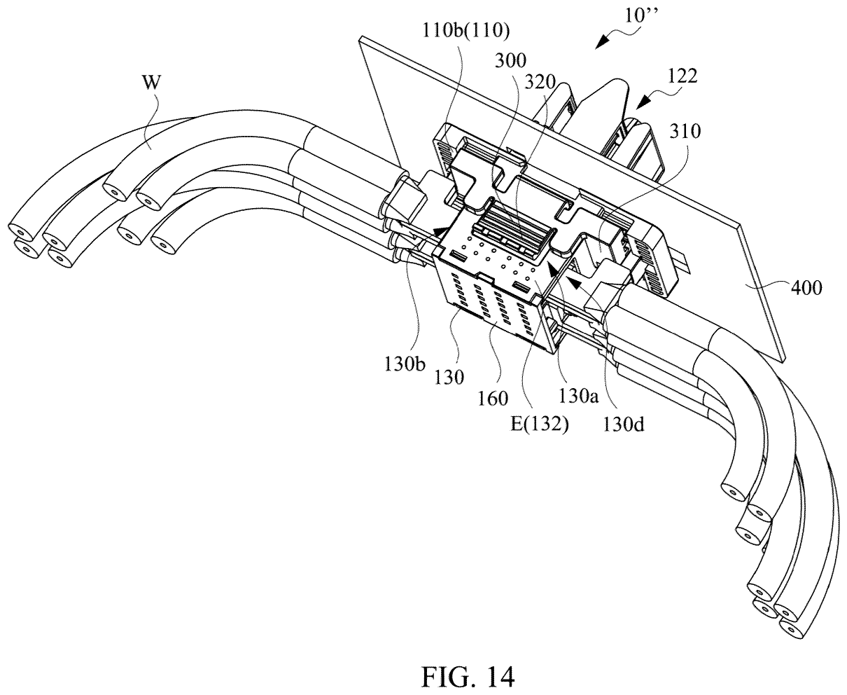

Reference is made to FIG. 13 and FIG. 14. FIG. 13 is a perspective view of a connector 10′ clamping a copper sheet CU according to another embodiment of the present disclosure. FIG. 14 is a perspective view of a connector 10″ with wires W connected on both sides according to another embodiment of the present disclosure. As shown in FIG. 13, in this embodiment, the connector 10′ is locked to the panel 400, and the first part 120 (not shown) of the connector 10′ can pass through the panel 400. The connector 10′ moves with the panel 400 so that the copper sheet CU is inserted into the slot 122 and clamped. Furthermore, the second part 130 of the connector 10′ can be connected to the wire W through the electric sheet 250. The wire W extends outward from the second side 130b of the second part 130, but the disclosure is not limited in this regard. In some embodiments, the wire W may only pass through the fourth side 130d. As shown in FIG. 14, in this embodiment, the electric sheet 250 of the connector 10″ can be connected to the wire W at the second side 130b and the fourth side 130d of the second part 130 at the same time. Compared to the connector 10 of FIG. 1, the portion of the electric sheet 250 exposed from the second part 130 of the insulating housing 100 extends toward the latch panel 110 and is wider in the first direction, thereby increasing the area connected to the connecting wire W to increase the conducting current. When the wire W extends from the second side 130b and the fourth side 130d of the second part 130, the first latch arm 310 of the latch member 300 is partially shielded by the wire W, and the operator cannot easily touch the first hook 312 of the first latch arm 310 to unlock the latch member 300. By disposing the second latch arm 320 on the first side 130a, the latch member 300 can be locked and released more easily.

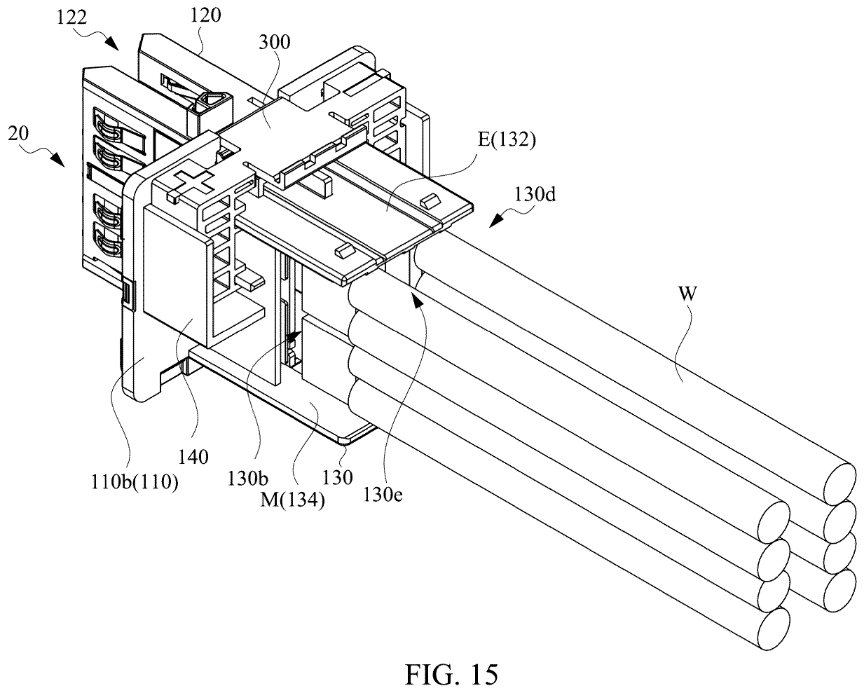

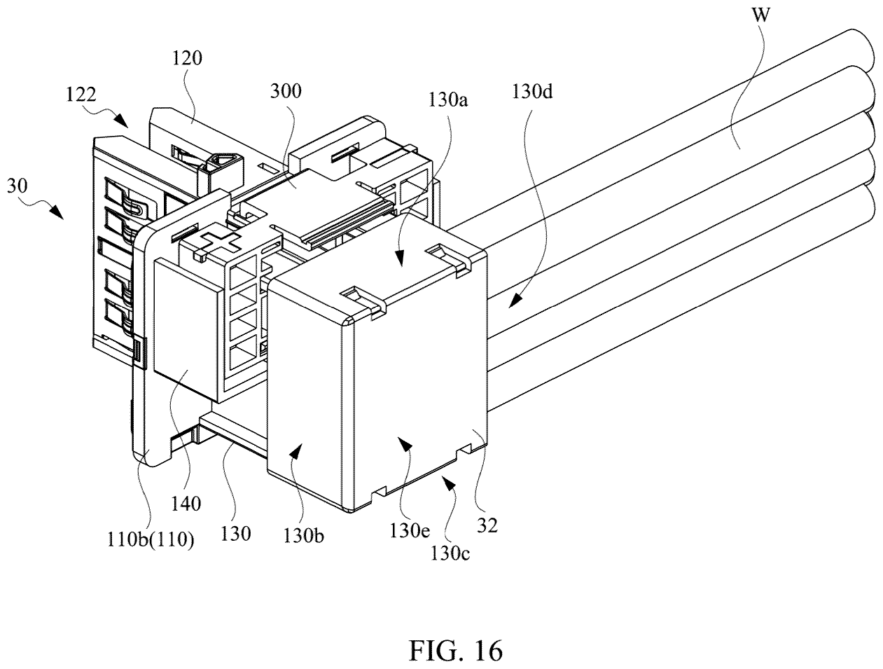

Reference is made to FIG. 15 and FIG. 16. FIG. 15 is a perspective view of a connector 20 according to another embodiment of the present disclosure. FIG. 16 is a perspective view of a connector 30 according to another embodiment of the present disclosure. As shown in FIG. 15, in this embodiment, the connector 20 only includes a slot 122, and a rear cover 160 is not included in the configuration of the connector 20. The wire W extends rearward from a fifth side 130e of the second part 130, wherein the fifth side 130e is a side of the second part 130 away from the latch panel 110. In this embodiment, the connector 20 may further provide a cover (not shown) detachably installed between the first extension plate 132 and the second extension plate 134 to cover the openings on the second side 130b and the fourth side 130d of the second part 130, or the second part 130 may have extension plates on four sides that surround a closed space and only form an outlet on the fifth side 130e. As shown in FIG. 16, in this embodiment, the cover 32 of the connector 30 covers the fifth side 130e of the second part 130, and partially covers the first side 130a, the second side 130b, and the third side 130c of the second part 130. The wire W is connected to the connector 30 and extends outward from the fourth side 130d of the second part 130.

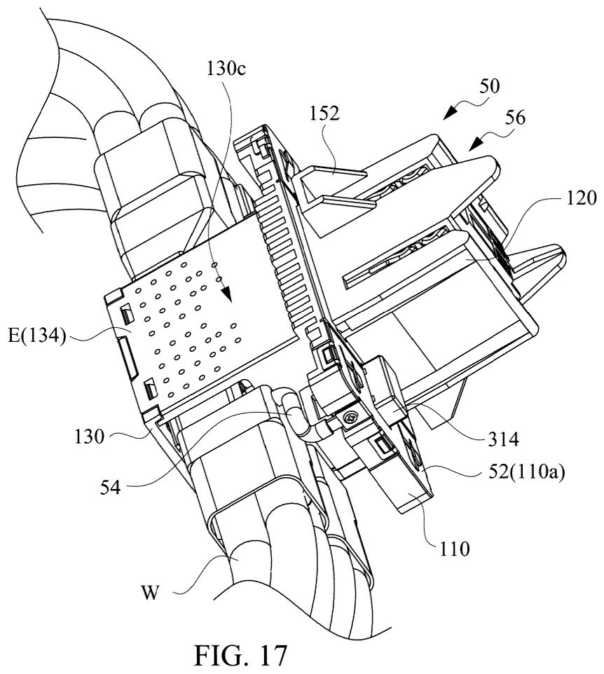

Reference is made to FIG. 17. FIG. 17 is a perspective view of a connector 50 according to another embodiment of the present disclosure. As shown in FIG. 17, in this embodiment, the first surface 110a of the latch panel 110 may further include a grounding sheet 52. The grounding sheet 52 is connected to the grounding wire 54, and the grounding wire 54 is connected to the grounding terminal in the slot 56; or one of the grounding wires W connected to the grounding terminal is used as the grounding wire 54 and connected to the grounding sheet 52, so that the grounding sheet 52 is electrically connected to the grounding copper sheet in the copper sheet CU. In some embodiments, the grounding sheet 52 can also pass through the insulating housing 100 through an extended elastic arm to directly contact the grounding terminal or the grounding wire W of the slot 56 to achieve common grounding. The extended elastic arm may an independent component connected with the grounding sheet 52 or be integrated with the grounding sheet 52.

According to the foregoing recitations of the embodiments of the disclosure, it can be seen that in the connector of the present disclosure, the latching portion is disposed on the first side of the second part, and the actuating portion of the latch member can be disposed on the side close to the operator to avoid being hindered by the wire, so that the latch member can be fastened and released more easily. When the pressing portion of the actuating portion is pressed, the rib of the latching portion and the recess on the first extension plate can make the pressing portion enter the recess, so that the second hook of the actuating portion is lifted up and leaves the rib by elastic deformation. By pressing the pressing portion and pushing (or pulling) the latch member toward the latch panel (or away from the latch panel) at the same time, the protrusion of the latch arm can be partially protruded from the first surface of the latch panel (or retracted into the latch opening without protruding from the first surface).

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A connector comprising:
an insulating housing comprising:
a latch panel having a first surface and a second surface opposite to each other, and a latch opening communicated with the first surface and the second surface;
a first part connected to the first surface and having at least one slot;
a second part connected to the second surface;
a latching portion; and
a guiding portion connected to the second surface;
at least one terminal set disposed in the slot; and
a latch member comprising:
an actuating portion configured to fasten the latching portion; and
a latch arm connected to the actuating portion and slidably engaged with the guiding portion and partially passing through the first surface via the latch opening when the actuating portion fastens the latching portion.

2. The connector of claim 1, wherein the guiding portion comprises a sliding groove communicated with the latch opening, the latch arm comprises a protrusion, the latch arm is slidably disposed in the sliding groove.

3. The connector of claim 1, wherein the latching portion is located at the second part, and the latching portion and the guiding portion are respectively located on a first side and a second side adjacent to the second part.

4. The connector of claim 3, wherein the second part has a first extension plate located on the first side, and the latching portion is disposed on an outer surface of the first extension plate.

5. The connector of claim 4, wherein the latching portion comprises a rib disposed on the outer surface, the actuating portion comprises a hook and a pressing portion, the hook is connected to the pressing portion, and the hook is configured to fasten the rib.

6. The connector of claim 5, wherein the outer surface has a recess, and the pressing portion is configured to be pressed to enter the recess, so that the actuating portion is separated from the latching portion.

7. The connector of claim 4, wherein the second part has a second extension plate located on a third side, the third side is opposite to the first side, and the insulating housing comprises a rear cover detachably covering a rear side of the first extension plate and the second extension plate away from the latch panel.

8. The connector of claim 5, wherein the actuating portion further comprises a pivot located between the hook and the pressing portion, and the pivot is configured to abut against the outer surface of the first extension plate to act as a rotation pivot.

9. The connector of claim 1, wherein the insulating housing further comprises two blocking blocks, the two blocking blocks are respectively connected to opposite sides of the first part and each forms a gap with the latch panel.

10. A connector comprising:
an insulating housing comprising:
a latch mechanism having a gap configured to receive a part of a panel;
a first part located on a first side of the latch mechanism and having at least one slot, the at least one slot having openings on three sides of the first part; and
a second part located on a second side of the latch mechanism opposite to the first side;
at least one terminal set disposed in the at least one slot; and
a latch member slidably disposed on the insulating housing and switching between a first state and a second state, wherein when the latch member is in the first state, the insulating housing is able to be installed on the panel and undergo a lateral movement, and when the latch member is in the second state, the latch member limits the lateral movement of the insulating housing relative to the panel.

11. The connector of claim 10, wherein the latch mechanism comprises:
a latch panel; and
at least one blocking block separated from the latch panel to form the gap.

12. The connector of claim 11, wherein the latch panel has a first surface and a second surface opposite to each other, and a latch opening communicated with the first surface and the second surface.

13. The connector of claim 12, wherein the latch member comprises:
a latch portion slidably and partially passing through the first surface via the latch opening; and
an actuating portion connected to the latch portion and configured to slide on an outer surface of the second part.

14. The connector of claim 13, wherein the insulating housing further comprises a guiding portion connected to the second surface and aligned with the latch opening, and the latch portion is slidably disposed in a sliding groove of the guiding portion.

15. The connector of claim 13, wherein the latch portion is located on one side of the second part, and the actuating portion is located on another side of the second part.
